(19) United States
(12) Patent Application Publication
(10) Pub. No.: US 2003/0163872 A1
(43) Pub. Date: Sep. 4, 2003

(54) Light bed frame with receiving frame for installing rehabilitation devices

(76) Inventor: Huang Chin Hsin, Chang-Hua City (TW)

Correspondence Address: Chin-Hsin Huang, PO BOX 487, Chang-Hua City, 500, TW

(21) Appl. No.: 10/245,636

(22) Filed: Sep. 18, 2002

(30) Foreign Application Priority Data
Mar. 1, 2002 (TW) 091202625

(51) Int. Cl. A61G 7/00

(52) U.S. Cl. 5/621; 5/622

(57) ABSTRACT

A light bed frame with a receiving frame serves for installing rehabilitation devices. A foldable light bed frame having an outer frame with a through hole thereon. Thereby, a positioning sleeve is capable of being inserted into the through hole. The receiving frame includes an oblong frame body; cambered rings at two long sides of the frame body, respectively; an extending tube; one end of the extending tube having a handle and another end being reduced to have a connecting section which can be inserted into a tube hole at one side of the frame body; a positioning sleeve for adjusting the extending tube. A post protruded from the plate is inserted into the through hole at the lateral frame of the light bed frame. An inner threaded hole is formed on the post so that a stud is threaded into the threaded hole of the post.

### BACKGROUND OF THE INVENTION

1. Field of the Invention

The present invention relates to rehabilitation device, and particularly to a light bed frame with a receiving frame for installing rehabilitation devices.

2. Description of Related Art

Commercial massage devices usually have compact volume and thus some other products which can be used with the massage devices are seldom developed. Therefore, users cannot assemble a plurality of rehabilitation devices as an integral body for being used easily. For example, the leg-massage devices only places on a front end of a chair, or is placed on a bed. However, these applications have many defects, for example, if a user uses the massage device as he sits on a chair and for a longer time, it is easily that the user will feel ache due to an improper pose. Furthermore, when the massage device is placed on a bed, the massage-device will move due to vibration. Users not only need to adjust the position of the massage device, but also he must move with the position change. However, all these induce a great convenience to the user. Once the massage device is actuated, it will vibrate, if the massage device can not be steadily fixed and massager will displace with the vibration frequency.

### SUMMARY OF THE INVENTION

Accordingly, the primary object of the present invention is to provide a light bed frame with a receiving frame for installing rehabilitation devices, wherein one end of a light bed frame is formed with a receiving frame, and four upper corners of the receiving frame are installed with circular seats for positioning the leg frames of a rehabilitation device.

Another object of the present invention is to provide a light bed frame with a receiving frame for installing rehabilitation devices, wherein an outer rod of the light bed frame has a sleeve for being inserted by an extending tube of a receiving frame, and the wall of the sleeve is installed with a hollow hole. A movable hollow hole is pivotally installed in the hollow portion. Thereby, the user may operate the convex seat at a bottom of the movable hollow hole so as to achieve the object of stability.

The various objects and advantages of the present invention will be more readily understood from the following detailed description when read in conjunction with the appended drawing.

### BRIEF DESCRIPTION OF THE DRAWINGS

FIG. 1 is a structural view of the present invention.

FIG. 2 is an assembled schematic view of the present invention,.

FIG. 3 is a partial exploded view of the sleeve of the receiving frame and the bed frame of the present invention.

FIG. 4 is an assembled cross section view of FIG. 3.

FIG. 5 is a plane view of the sleeve of the receiving frame of the present invention.

FIG. 6 is a partial cross sectional view of the sleeve of the present invention.

FIG. 7 shows the embodiment of the present invention which is used with a rehabilitation device.

FIG. 8 shows one embodiment that the receiving frame of the present invention which is used with a bed pad.

### DETAILED DESCRIPTION OF THE PREFERRED EMBODIMENTS

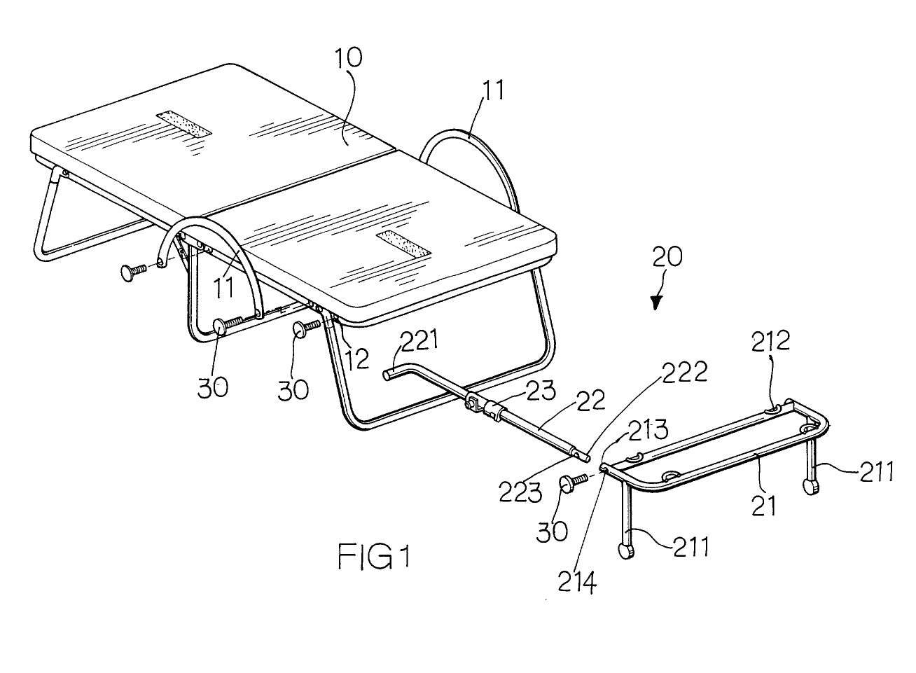

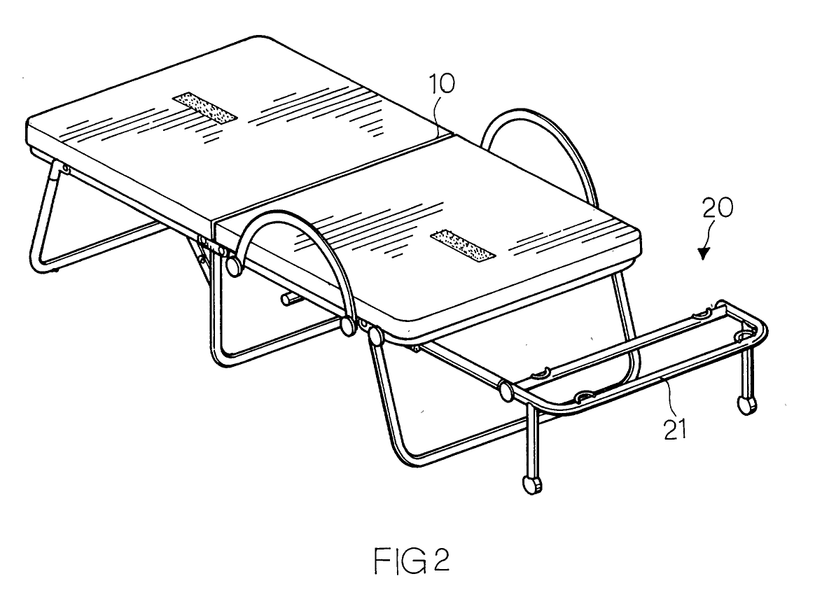

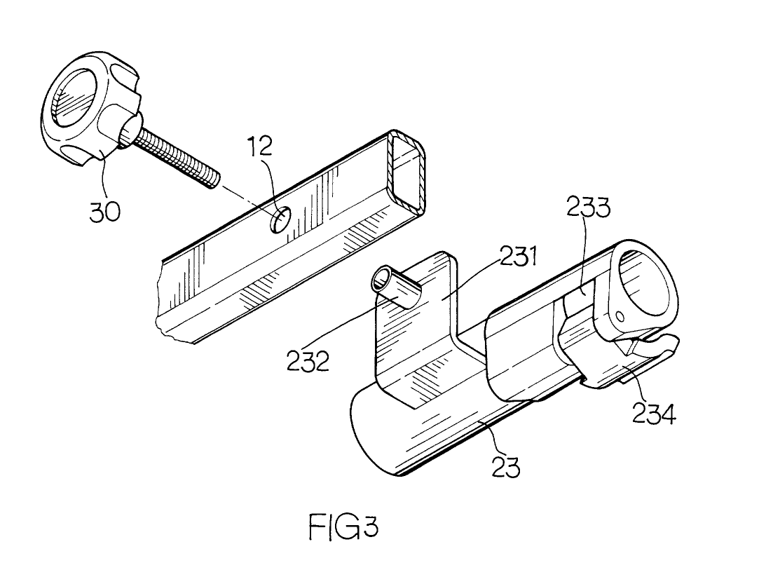

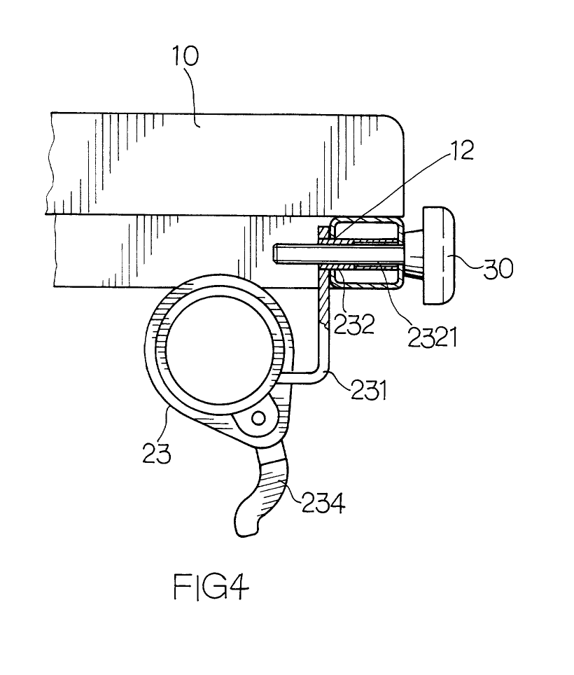

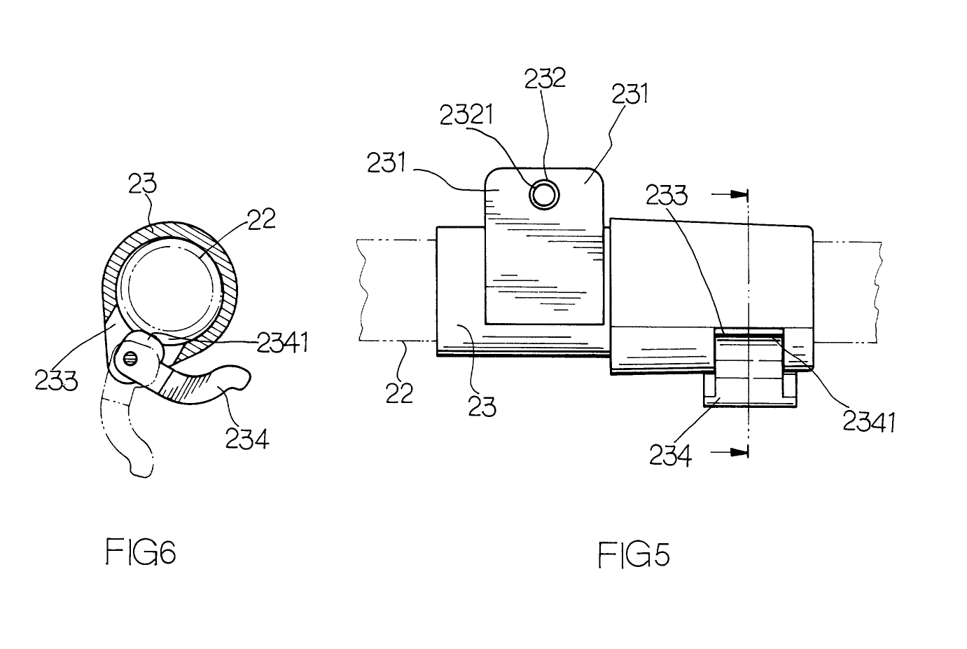

At first, referring to FIGS. 1 to 6, the light bed frame of the present invention can be placed in a receiving frame of a rehabilitation device. The light bed frame 10 is a foldable bed. Two lateral sides thereof have control handles 11 which can be locked and positioned by studs 30 and one end thereof is connected to a receiving frame 20. The distance between the light bed frame 10 and the receiving frame 20 is adjustable according to the pose or height of the user. The receiving frame 20 serves for placing a leg rehabilitation device 40 (or a leg massage device) steadily.

The outer lateral frame at one end of the light bed frame 10 has a through hole 12 for being inserted by tube of a positioning sleeve.

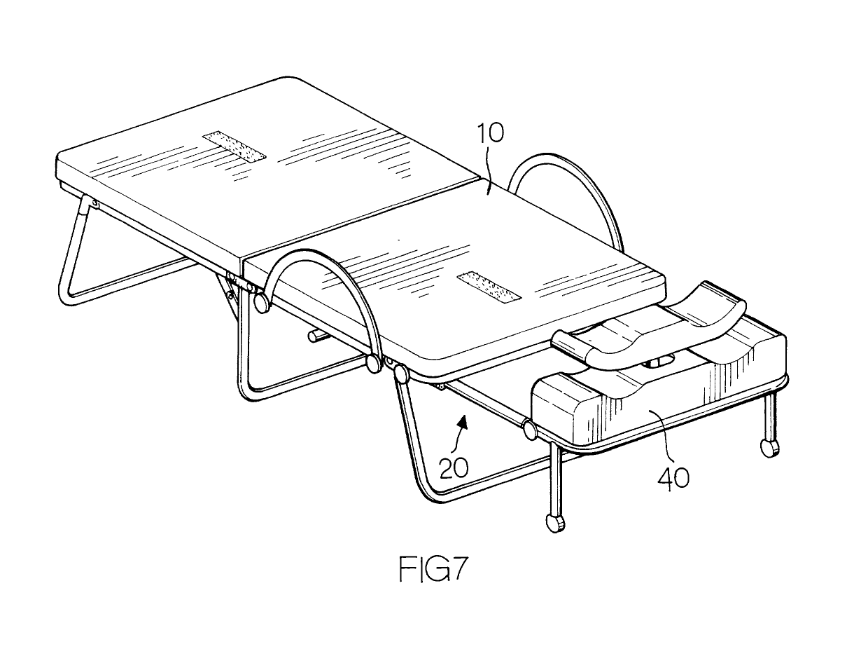

The receiving frame 20 has an oblong frame body 21, an extending tube 22, and a positioning sleeve 23. Two sides of the oblong frame body 21 have leg frames 211. Two long sides of the frame body 21 have two cambered rings 212 which are extended toward the center of the oblong shape. Thereby, the posts of a rehabilitation device 40 can be buckled to the cambered rings 212 for being positioned therein (referring to FIG. 7). One end of the extending tube 22 has a handle 221 and another end is reduced to have a connecting section 222 which can be inserted into a tube hole 213 at one side of the frame body 21. The connecting section 222 has a via hole 223. The tube hole 213 has a round hole 214 at position with respect to the via hole 223. Thereby, it can be fixed by a stud 30. The positioning sleeve 23 serves for adjusting the extending tube 22. One end of the positioning sleeve 23 is formed with an L shape plate 231. A post 232 protruded from the plate is inserted into the through hole 12 at the lateral frame of the light bed frame 10. An inner threaded hole 2321 is installed in the post 232. The tube wall at the other end of the positioning sleeve 23 has a hollow hole 233. The hollow hole 233 is pivotally installed with a movable control handle 234. A protruding seat 2341 at a lower end of the control handle 234 can be inserted into the inner tube wall of the positioning sleeve 23 to tightly press the tube wall of the extending tube 22, causing the extending tube 22 to be positioned steadily. When the control handle 234 is pressed downwards, the protruding seat 2341 will retract from the inner tube wall of the positioning sleeve 23. When the control handle 234 resists against the protruding seat 2341, it can be extended from the inner tube wall of the positioning sleeve 23. Thereby, by the portion of the protruding seat 2341 protruded from the inner tube wall of the positioning sleeve 23 to resist tightly against the extending tube 22 in the positioning sleeve 23, the receiving frame 20 can be positioned at one end of the light bed frame 10.

By above components, at first, the extending tube 22 is inserted into the positioning sleeve 23 and the connecting section 222 at one end of the extending tube 22 is inserted into the tube hole 213 at one side of the oblong frame body 21. Then, the via hole 223 of the extending tube 22 and the round hole 214 of the tube hole 231 are adjusted to be not at the same axial line. Then the screw rod 30 is locked to complete the positioning operation. Thereby, the post 232 at the L shape plate 231 at one end of the positioning sleeve 23 can be inserted into the through hole 12 from a predetermined end of the light bed frame 10. The screw rod 30 is screwed into the inner threaded hole 2321 of the post 232 unit it is steadily positioned. Thus, the assembly of the whole components is finished.

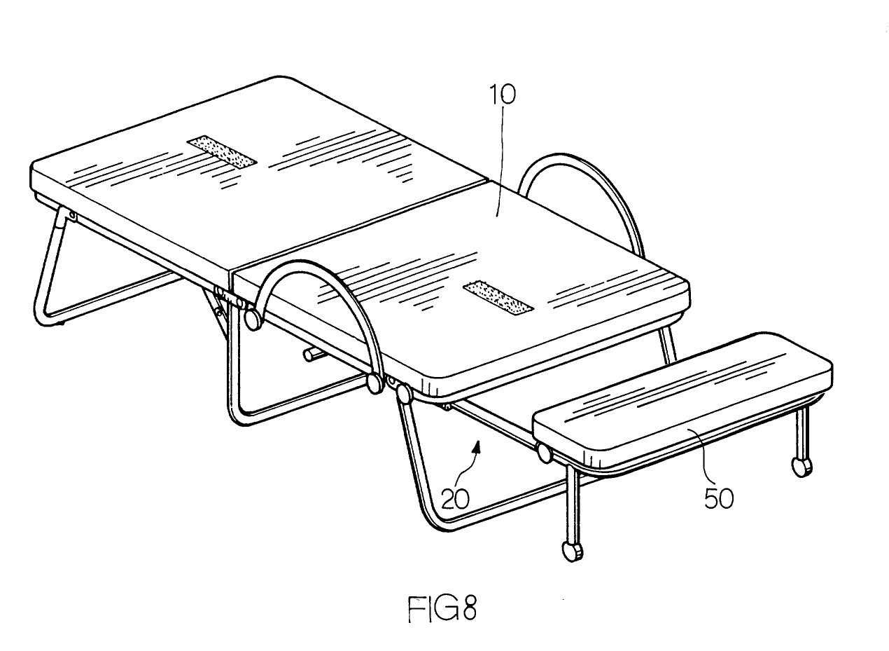

Moreover, referring to FIG. 7, it is illustrated that the light bed frame of the present invention is added with a receiving frame for placing a rehabilitation device and moreover, a leg swinging massage device is added. When the user lies on the light bed frame, the control handle 234 of the positioning sleeve 23 is pressed downwards, so that the protruding seat 2341 original resisting against the tube wall of the extending tube 22 retracts. The bending handle 221 at one end of the extending tube 22 is held so as to adjust the distance between the receiving frame 20 and the light bed frame 10. After completing the adjustment operation, the control handle 234 is moved backwards, so that the protruding seat 2341 of the control handle 234 resists against the tube wall of the extending tube 22 again to achieve the effect of positioning. Thereby, the distance between the light bed frame 10 and the receiving frame 20 is suitable for the height and pose of the user. Referring to FIG. 8, when the frame body 21 of the receiving frame 20 dose not support any rehabilitation device, a bed pad 50 can be placed thereon so as to be as a leisure bed. A bottom of the bed pad with respect to the cambered rings 212 of the frame body 21 has legs for positioning the bed pad 50.

Furthermore, the light bed frame 10 and receiving frame 20 of the present invention can be designed as a foldable and detachable structure. When it is detached, the whole volume can be reduced so as to occupied less space. Moreover, after the post 232 protruded from the L shape plate 231 at one end of the positioning sleeve 23 is inserted into the through hole 12 of the light bed frame 10, it can be rotated through any desired angle for suiting the evenness of the ground. By fine-adjusting the angle of the positioning sleeve 23, it can be corrected so that the receiving frame 20 is more successful.

In above mentioned light bed frame, only one side is installed with a positioning sleeve, when the extending tube is inserted in the positioning sleeve for moving forwards or backwards, the distance between the light bed frame and the receiving frame is adjustable. The receiving frame is guided by a single extending tube so that the displacement of the receiving frame is easy and successfully. Moreover, the ends of the light bed frame and the receiving frame with respect to the extending tubes are opened, and thus the old peoples or other maimed people may lie on the bed easily.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A light bed frame with a receiving frame for installing rehabilitation devices, wherein a foldable light bed frame having an outer frame with a through hole thereon; thereby, a positioning sleeve is capable of being inserted into the through hole; the receiving frame includes
an oblong frame body; two sides of the frame body having extended leg frames which are symmetrical and have respective rotary wheels;
cambered rings being at two long sides of the frame body, respectively, which are extended toward a center of the oblong frame body; thereby, posts of a rehabilitation device being buckled to the cambered rings for being positioned therein;
an extending tube; one end of the extending tube having a handle and another end being reduced to have a connecting section which can be inserted into a tube hole at one side of the frame body by a stud; and
a positioning sleeve for adjusting the extending tube; one end of the positioning sleeve being formed with an L shape plate; a post protruded from the L shape plate being inserted into the through hole at the lateral frame of the light bed frame; an inner threaded hole being formed on the post so that a stud is threaded into the threaded hole of the post.

2. The light bed frame with a receiving frame for installing rehabilitation devices as claimed in claim 1, wherein the tube wall at the other end of the positioning sleeve has a hollow hole; the hollow hole is pivotally installed with a movable control handle; when the control handle is pressed; a protruding seat at a bottom end of the pivotal end of the control handle has a part protruded from an inner tube wall of the positioning sleeve; thereby, by the portion of the protruding seat protruded from an inner tube wall of the positioning sleeve to resist tightly against the extending tube in the positioning sleeve, the receiving frame is capable of being positioned at one end of the light bed frame.

3. The light bed frame with a receiving frame for installing rehabilitation devices as claimed in claim 1, wherein when the control handle is pressed downwards, a bottom end of a pivotal end of the control handle retracts from an inner tube wall of the sleeve completely so that the extending tube of the receiving frame is adjustable in a forward direction or a backward direction.
